(19) United States
(12) Patent Application Publication
(10) Pub. No.: US 2022/0298443 A1
(43) Pub. Date: Sep. 22, 2022

(54) PLANT AND PROCESS FOR OBTAINING BIOMETHANE IN ACCORDANCE WITH THE SPECIFICITIES OF A TRANSPORT NETWORK

(71) Applicant: L'Air Liquide Societe Anonyme pour l'Etude et l'Exploitation des Procedes Georges Claude, Paris (FR)

(72) Inventors: Youssef TAZI, Houston, TX (US); Laura AYRAULT, Sassenage (FR); Veronique GRABIE, Sassenage (FR)

(73) Assignee: L'Air Liquide Societe Anonyme pour l'Etude et l'Exploitation des Procedes Georges Claude, Paris (FR)

(21) Appl. No.: 17/701,260

(22) Filed: Mar. 22, 2022

(30) Foreign Application Priority Data
Mar. 22, 2021 (FR) FR 2102829

(51) Int. Cl. C10L 3/10; B01D 53/047

(52) U.S. Cl. CPC C10L 3/104; C10L 3/106; B01D 53/047; C10L 2290/10; C10L 2290/542; C10L 2290/548; C10L 2290/58; C10L 2290/60; B01D 2257/504; B01D 2257/80; B01D 2256/245

(57) ABSTRACT

Methane and carbon dioxide-containing feed gas stream is compressed and cooled to condense and remove a portion of water therein, separated with a membrane separation unit into a permeate enriched in carbon dioxide and a biomethane stream scrubbed of CO₂ that is subsequently scrubbed of water in an adsorption purification unit.

### CROSS-REFERENCE TO RELATED APPLICATIONS

This application claims the benefit of priority under 35 U.S.C. § 119 (a) and (b) to French patent application No. FR 2102829, filed Mar. 22, 2021, the entire contents of which are incorporated herein by reference.

### BACKGROUND

### Field of the Invention

The present invention relates to a plant and a process for producing biomethane, scrubbed of carbon dioxide and of water, from a feed gas stream comprising methane and carbon dioxide, preferably biogas or biomethane.

### Related Art

Biogas is the gas produced during the degradation of organic matter in the absence of oxygen (anaerobic fermentation), also known as methanization. This can be natural decomposition. It is thus observed in marshland or in household waste landfills. However, the production of biogas can also result from the methanization of waste in a dedicated reactor, known as methanizer or digester.

Owing to its main constituents, methane and carbon dioxide, biogas is a powerful greenhouse gas. At the same time, it also constitutes a source of renewable energy, which is appreciable in the context of the increasing scarcity of fossil energy sources.

Biogas predominantly contains methane (CH₄) and carbon dioxide (CO₂) in proportions which can vary according to the way in which it is obtained. It also contains, in smaller proportions, water, nitrogen, hydrogen sulfide, oxygen, as well as other organic compounds, in trace amounts.

Depending on the organic matter which has been degraded and on the techniques used, the proportions of the components differ. But on average, biogas comprises (on a dry gas basis) 30-75% methane, 15-60% CO₂, 0-15% nitrogen, 0-5% oxygen and trace compounds.

Biogas is upgraded in various ways. It can, after minor treatment, be upgraded close to the production site to supply heat, electricity or a mixture of both in a process called cogeneration. The high carbon dioxide content reduces its calorific value, increases the costs of compression and transportation, and limits the economic advantage of upgrading it to this nearby use.

More intensive purification of biogas allows it to be more widely used. In particular, intensive purification of biogas makes it possible to obtain a biogas which has been purified to the specifications of natural gas and which can be substituted for the latter. Biogas thus purified is known as “biomethane”. Biomethane thus supplements natural gas resources with a renewable part produced within territories. It can be used for exactly the same uses as natural gas of fossil origin. It can supply a natural gas network or a vehicle filling station. It can also be liquefied to be stored in the form of liquefied natural gas (LNG).

The ways of upgrading biomethane are determined according to the local contexts, such as local energy requirements, the possibilities of upgrading as biomethane fuel, and the existence of nearby natural gas distribution or transportation networks. By creating synergies between the various parties operating in a given territory, such as farmers, manufacturers, and public authorities, the production of biomethane helps the territories to acquire greater energy self-sufficiency.

Several steps need to be completed between collecting the biogas and obtaining the biomethane which is the end product capable of being compressed or liquefied.

Carbon dioxide is a contaminant typically present in natural gas, from which it is common to have to strip it.

Water however is a contaminant which has rarely been removed to very low contents. Specifically, the water content to be achieved is generally of the order of 100 to 300 ppm, because such water levels are sufficient for the distribution network. For example, the distribution network may require a water dew point below −5° C. at the maximum operating pressure (4-8 barg) of the network.

### SUMMARY OF THE INVENTION

In the context of the present invention, it is desired to be able to compress the biomethane to a level requiring a more thorough removal of water so as to be able to interconnect a distribution network operating at low pressure, typically between 4 and 8 bar, and a transport network operating between 40 and 70 bar.

This “reverse” operation aims to “decongest” the network to make sure that the number of forthcoming projects is not limited by the space in the distribution network.

Starting from that point, one problem that is faced is to provide a plant and a process for obtaining biomethane scrubbed of carbon dioxide and of water in order to be in accordance with the specificities of the transport network operating at higher pressure.

One solution of the present invention is a plant for producing biomethane B, scrubbed of CO₂ and of water, from a feed gas stream A comprising methane and carbon dioxide comprising:
a compressor 0 for compressing the feed gas stream,
a cooler 1 for cooling the compressed feed gas stream so as to condense at least one portion of the water included in the feed gas stream;
a means 2 for removing at least one portion of the condensed water in the feed gas stream,
a membrane separation unit 4 capable of receiving the feed gas stream resulting from the means 2 and of providing a permeate enriched in carbon dioxide and biomethane scrubbed of carbon dioxide, and
an adsorption purification unit 5 for removing at least one portion of the water remaining in the biomethane scrubbed of carbon dioxide and recovering biomethane scrubbed of carbon dioxide and of water.

According to the case in hand, the plant according to the invention may have one or more of the characteristics below:
the adsorption purification unit 5 comprises at least one adsorber and the plant comprises a means R for regenerating the adsorber using a portion of the feed gas stream resulting from the means 2 as regeneration gas; note that this portion of the biogas resulting from the means 2 will preferably be heated in a heater, preferably to a temperature above 150° C.,
the plant comprises a means for recovering a regeneration gas at the outlet of the adsorber and a means for recycling the regeneration gas upstream of the compressor 0;
the plant comprises, between the means for recovering the regeneration gas and the means for recycling the regeneration gas, a cooler 7 for cooling the regeneration gas so as to condense at least one portion of the water included in the regeneration gas and a means 8 for removing at least one portion of the condensed water in the regeneration gas;
the adsorber comprises an adsorbent chosen from alumina or molecular sieve;
the plant comprises a heat exchanger 3 for heating the feed gas stream resulting from the means 2 before the entry thereof into the membrane separation unit 4;
the plant comprises an analyser 12 for measuring the concentration of CO₂ and/or of water in the biomethane B scrubbed of carbon dioxide and of water.

The plant may also comprise an analyser for measuring the concentration of CO₂ and/or of water in the biomethane scrubbed of carbon dioxide at the outlet of the membrane separation unit.

Note that the adsorption purification unit will preferably be of PSA (pressure swing adsorption) type.

The purification unit will preferably comprise at least two adsorbers which follow, with an offset, a pressure cycle comprising an adsorption (purification) phase and a regeneration phase.

The membrane separation unit will preferably comprise only a single membrane stage. In other words, the retentate will not be sent to a second membrane stage.

Another subject of the present invention is a process for producing biomethane B, scrubbed of CO₂ and of water, from a feed gas stream A comprising methane and carbon dioxide, using a plant according to the invention, and comprising:
a) a step of compressing 0 the feed gas stream A,
b) a step of cooling 1 the compressed feed gas stream so as to condense at least one portion of the water included in the feed gas stream,
c) a step of removing 2 at least one portion of the condensed water in the feed gas stream,
d) a step of membrane separation of the methane and of the carbon dioxide in the gas stream resulting from step c) in the membrane separation unit 4 so as to recover a permeate 10 enriched in carbon dioxide and a biomethane stream 11 scrubbed of carbon dioxide,
e) a step of recovering a biomethane stream 11 scrubbed of carbon dioxide,
f) a step of adsorption purification in the adsorber 5 of the stream of biomethane 11 resulting from step e) so as to remove at least one portion of the water remaining in the biomethane stream 11, and
g) a step of recovering biomethane B scrubbed of carbon dioxide and of water.

Depending on the case, the process according to the invention may have one or more of the features below:
The process comprises a step of regenerating the adsorber using a portion R of the gas stream resulting from step c) as regeneration gas.
The process comprises a step of recovering the regeneration gas at the outlet of the adsorber and a step of recycling this regeneration gas upstream of the compression.
The process comprises, between the step of recovering the regeneration gas and the step of recycling the regeneration gas, a cooling step 7 so as to condense at least one portion of the water included in the regeneration gas and a step of removing 8 at least one portion of the condensed water in the regeneration gas.
The process comprises a step of heating the biogas resulting from step c).
The process comprises a step of measuring 12 the concentration of CO2 and/or of water in the biomethane B scrubbed of carbon dioxide and of water.
In step a) the feed gas stream is compressed 0 to a pressure greater than 60 bar.
In step b) the feed gas stream is cooled 1 to a temperature below 15° C.
The feed gas stream A is chosen from biogas or biomethane.

The present invention will now be described in more detail using FIG. 1.

### BRIEF DESCRIPTION OF THE FIGURES

FIG. 1 illustrates an example of a plant according to the invention.

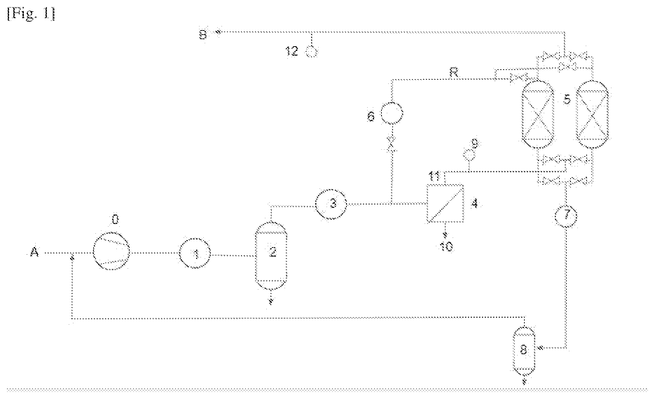

### DETAILED DESCRIPTION OF THE INVENTION

In the context of this example, the feed gas stream A is biomethane comprising 3.5% of CO₂, 800 ppm of water and the remainder is methane; it has a flow rate of 760 Nm³/h and a pressure of 3.5 bar. The biomethane A is firstly compressed in a compressor 0 to a pressure of 62 bar before being cooled 1 to a temperature of 5° C. This cooling makes it possible to condense the water which is removed in a separator 2. 80% of the water initially included in the biomethane A is thus removed. The biogas is then heated to a temperature of 15° C. in an exchanger 3 before being introduced into the membrane separation unit 4. This membrane separation unit 4 comprises at least one membrane permeable to carbon dioxide and thus makes it possible to recover a permate 10 enriched in carbon dioxide and biomethane 11 scrubbed of carbon dioxide, that is to say comprising in the present case 2.5% carbon dioxide. The biomethane 11 scrubbed of carbon dioxide is analysed in the analyser 9 in order to control the concentration of CO2 and/or of water before being introduced into the adsorption purification unit 5 in order to remove at least one portion of the water remaining in the biomethane scrubbed of carbon dioxide. The adsorption purification unit 5 comprises two adsorbers which each follow, with an offset, a pressure cycle comprising an adsorption phase and a regeneration phase. These adsorbers each comprise an adsorbent for adsorbing water, chosen from alumina and molecular sieve. Biomethane scrubbed of carbon dioxide and of water is recovered at the outlet of the adsorption purification unit. It comprises precisely 2.5% of CO₂, less than 40 ppm of water and the remainder is methane. This composition is verified in the analyser 12. The adsorbent of the adsorbers is regenerated using a portion R of the biogas exiting the exchanger 3. This portion R of the biomethane is heated in a heater 6 to a temperature of 150° C. before being introduced as regeneration gas into the adsorber in regeneration mode of the adsorption purification unit 5. Recovered at the outlet of the adsorption purification unit 5 is the regeneration gas which is cooled at 20° C. in a cooler 7, which makes it possible to condense at least one portion of the water included in the regeneration gas. This condensed water will be removed 8 before being recycled upstream of the compressor 0.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for producing biomethane that is scrubbed of CO₂ and of water, from a feed gas stream comprising methane and carbon dioxide, comprising the steps of:
compressing the feed gas stream with a compressor, thereby producing a compressed feed gas stream;
cooling the compressed feed gas stream so as to condense at least one portion of water in the compressed feed gas stream;
removing at least one portion of the condensed water in the feed gas stream, thereby producing a water-depleted compressed feed gas stream;
separating the water-depleted compressed feed gas stream with a membrane separation unit into a permeate enriched in carbon dioxide and a biomethane stream scrubbed of carbon dioxide;
recovering the biomethane stream scrubbed of carbon dioxide from the membrane separation unit;
removing at least one portion of water remaining in the recovered biomethane stream scrubbed of carbon dioxide with an adsorption purification unit comprising an adsorber to produce biomethane scrubbed of carbon dioxide and water; and
recovering the biomethane scrubbed of carbon dioxide and water from the adsorption purification unit.

2. The process of claim 1, further comprising regenerating the adsorber by using a portion of the water-depleted compressed feed gas stream as regeneration gas.

3. The process of claim 2, further comprising recovering the regeneration gas at an outlet of the adsorber and recycling the recovered regeneration gas in said process upstream of the compressor.

4. The process of claim 3, further comprising the steps of:
cooling the recovered regeneration gas so as to condense at least one portion of water in the regeneration gas, said step of cooling the regeneration gas being performed between said step of recovering the regeneration gas and said step of recycling the recovered regeneration gas; and
removing the at least one portion of condensed water from the regeneration gas.

5. The process of claim 1, further comprising heating the water-depleted compressed feed gas stream in a heat exchanger.

6. The process of claim 1, further comprising measuring a concentration of CO₂ and/or of water in the recovered biomethane scrubbed of carbon dioxide and water.

7. The process of claim 1, wherein the feed gas stream is compressed to a pressure greater than 60 bar.

8. The process of claim 1, wherein the compressed feed gas stream is cooled to a temperature below 15° C.

9. The process of claim 1, wherein the feed gas stream is chosen from biogas or biomethane.

10. The process of claim 1, wherein the adsorber comprises an adsorbent chosen from alumina or molecular sieve.
